(19) United States
(12) Patent Application Publication
(10) Pub. No.: US 2016/0325671 A1
(43) Pub. Date: Nov. 10, 2016

(54) GALLEY PULLOUT

(71) Applicant: Allied Recreation Group, Inc., Decatur, IN (US)

(72) Inventor: Paul White, Milford, MI (US)

(21) Appl. No.: 14/705,665

(22) Filed: May 6, 2015

(51) Int. Cl. B60P 3/36; A47B 46/00; A47B 77/02; A47B 45/00

(52) U.S. Cl. CPC B60P 3/36; A47B 45/00; A47B 46/00; A47B 77/02

(57) ABSTRACT

A cabinet assembly includes a cabinet case, a pullout enclosure, and a removable countertop piece. The pullout enclosure is slidable between retracted and extended positions. In the retracted position, a retractable section of the enclosure is received in a pocket of the cabinet case and an exposed section of the enclosure is not received in the pocket. In the extended position, neither the retractable section nor the exposed section are received in the pocket. The countertop piece is configured for insertion into the space between countertops of the cabinet case and the pullout enclosure when the pullout enclosure is in the extended position to thereby lock the pullout enclosure in the extended position. The countertop piece is also configured for removal from the space between the countertops to permit sliding of the pullout enclosure from the extended position into the retracted position.

### BACKGROUND

1. Field

The present invention relates generally to cabinetry. More specifically, embodiments of the present invention concern a cabinet assembly with a cabinet case, a pullout enclosure, and a removable countertop piece.

2. Discussion of Prior Art

Cabinets have long been used to provide organized and convenient storage in various types of work and living spaces. While cabinets are ubiquitous in homes and other fixed structures, cabinets are also commonly found in recreational vehicles. For instance, conventional recreational vehicles include a galley to prepare and serve meals. Structures within prior art recreational vehicles include collapsible features so that the living space within the vehicle can be reconfigured and optimized as desired by the user.

However, prior art recreational vehicles have certain deficiencies. For example, galleys of known vehicles lack sufficient countertop work space and storage space for preparing and serving food and related activities. Additionally, known galleys take up too much space within the vehicle. Consequently, there is a need for cabinetry that provides additional work and storage space while taking up minimal living space within the vehicle.

### SUMMARY

The following brief summary is provided to indicate the nature of the subject matter disclosed herein. While certain aspects of the present invention are described below, the summary is not intended to limit the scope of the present invention.

Embodiments of the present invention provide a cabinet assembly that does not suffer from the problems and limitations of the prior art cabinetry set forth above.

A first aspect of the present invention concerns a cabinet assembly operable to support items above a floor. The cabinet assembly broadly includes a cabinet case, a pullout enclosure, and a removable countertop piece. The cabinet case is operable to be mounted on the floor and at least partly defines a cabinet pocket. The pullout enclosure is operable to receive one or more of the items and is slidably attached to the cabinet case. The pullout enclosure is slidable relative to the cabinet case between a retracted position and an extended position. The pullout enclosure comprises an exposed section and a retractable section. The pullout enclosure is configured such that when the pullout enclosure is in the retracted position, the retractable section is received in the pocket and the exposed section is not received in the pocket. The pullout enclosure is configured such that when the pullout enclosure is in the extended position, neither the retractable section nor the exposed section are received in the pocket. The cabinet case and the pullout enclosure comprise respective countertops that are adjacent to one another when the pullout enclosure is in the retracted position and spaced from one another when the pullout enclosure is in the extended position. The countertop piece is configured for insertion into the space between the countertops of the cabinet case and the pullout enclosure when the pullout enclosure is in the extended position to thereby lock the pullout enclosure in the extended position. The countertop piece is also configured for removal from the space between the countertops of the cabinet case and the pullout enclosure to thereby permit sliding of the pullout enclosure from the extended position into the retracted position.

A second aspect of the present invention concerns a vehicle that broadly includes a vehicle chassis, a slideout, and a cabinet assembly. The slideout cooperates with the chassis to define an enclosed space. The slideout is shiftably mounted to the chassis and is slidable into and out of the chassis to change the size of the enclosed space. The cabinet assembly is operable to support items in the enclosed space and broadly includes a cabinet case, a pullout enclosure, and a removable countertop piece. The cabinet case is mounted in the enclosed space and at least partly defines a cabinet pocket. The pullout enclosure is operable to receive one or more of the items and is slidably attached to the cabinet case. The pullout enclosure is slidable relative to the cabinet case between a retracted position and an extended position. The pullout enclosure comprises an exposed section and a retractable section. The pullout enclosure is configured such that when the pullout enclosure is in the retracted position, the retractable section is received in the pocket and the exposed section is not received in the pocket. The pullout enclosure is configured such that when the pullout enclosure is in the extended position, neither the retractable section nor the exposed section are received in the pocket. The cabinet case and the pullout enclosure comprise respective countertops that are adjacent to one another when the pullout enclosure is in the retracted position and spaced from one another when the pullout enclosure is in the extended position. The countertop piece is configured for insertion into the space between the countertops of the cabinet case and the pullout enclosure when the pullout enclosure is in the extended position to thereby lock the pullout enclosure in the extended position. The countertop piece is configured for removal from the space between the countertops of the cabinet case and the pullout enclosure to thereby permit sliding of the pullout enclosure from the extended position into the retracted position.

A third aspect of the present invention concerns a method of adjustably configuring a cabinet assembly that includes a cabinet case and a pullout assembly, with the case presenting a pocket to receive the pullout assembly, and with the cabinet case and the pullout assembly including respective countertops. The method broadly includes the steps of sliding the pullout assembly from a retracted position, where the retractable section of the pullout assembly is received in the pocket, to an extended position, where the retractable section is outside of the pocket; inserting a countertop piece into the space between the countertops of the cabinet case and the pullout enclosure to lock the pullout enclosure in the extended position; removing the countertop piece from the space between the countertops to permit sliding of the pullout enclosure toward the retracted position; and sliding the pullout assembly from the extended position to the retracted position.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a fragmentary perspective of a vehicle constructed in accordance with a preferred embodiment of the present invention, showing a cabinet assembly installed in a slideout of the vehicle to provide a galley, with the slideout in an inboard position and a pullout enclosure of a cabinet assembly in a retracted position;

FIG. 2 is a fragmentary perspective of the vehicle similar to FIG. 1, but showing the slideout in an outboard position and the pullout enclosure extending laterally from a cabinet case in an extended position;

FIG. 3 is a perspective of the cabinet assembly shown in FIGS. 1 and 2, showing the pullout enclosure extended and a countertop piece removed to allow the pullout enclosure to be returned to the retracted position;

FIG. 4 is a perspective of the countertop piece shown in FIGS. 2 and 3, showing recessed margins and bosses along a lower surface of the countertop piece;

FIG. 5 is a fragmentary upper rear perspective of the cabinet assembly shown in FIGS. 1-3, showing the pullout enclosure in the extended position, with the cabinet case including a slide base connected to the pullout enclosure by roller slides;

FIG. 6 is a fragmentary lower rear perspective of the cabinet assembly shown in FIGS. 1-3 and 5, showing a base, a support frame, and a roller of the pullout enclosure;

FIG. 7 is a fragmentary cross section of the cabinet assembly shown in FIGS. 1-3, 5, and 6, showing a pullout lock of the cabinet assembly in a locked position to secure the pullout enclosure in the extended position;

FIG. 8 is a fragmentary cross section of the cabinet assembly similar to FIG. 7, but showing the pullout enclosure locked in the retracted position by the pullout lock;

FIG. 9 is a fragmentary cross section of the cabinet assembly shown in FIGS. 1-3 and 5-8, showing the pullout enclosure supported within a pocket of the cabinet case; and

FIG. 10 is a fragmentary top view of the cabinet assembly shown in FIGS. 1-3 and 5-9, showing the space between countertops of the cabinet case and the pullout enclosure when the pullout enclosure is in the extended position.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

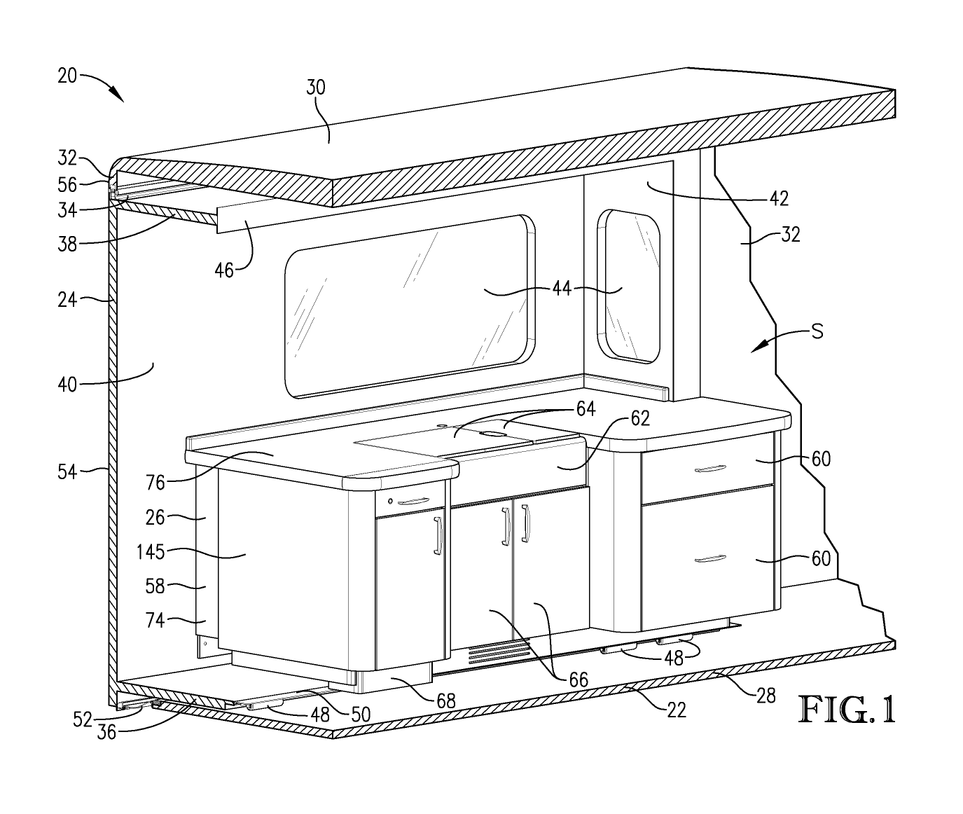

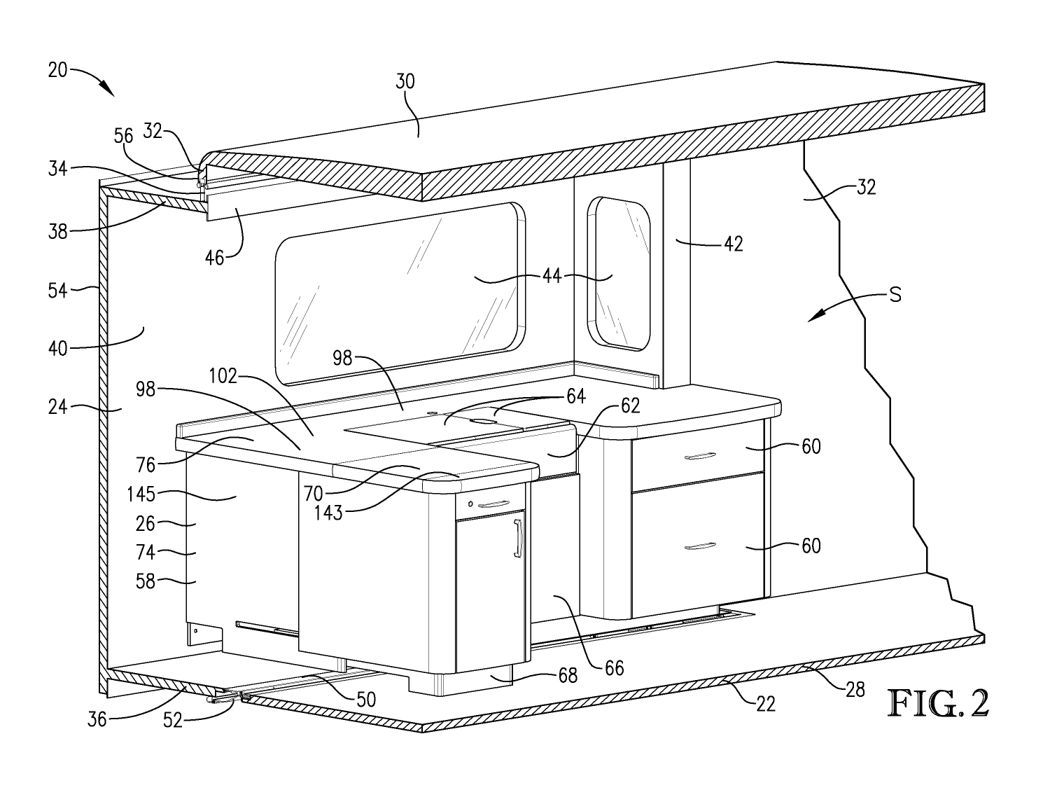

Turning initially to FIGS. 1 and 2, a recreational vehicle 20 is constructed in accordance with a preferred embodiment of the present invention. In the usual manner, the vehicle 20 presents an enclosed space S for one or more occupants to use.

The illustrated vehicle 20 includes a powered vehicle chassis 22, a slideout 24, and a cabinet assembly 26. The chassis 22 includes a chassis floor 28, a roof 30, a side wall 32, and a seal 34. As is customary, the vehicle 20 is used to transport occupants across various roads. At the same time, the vehicle 20 provides a living space for occupants, whether the vehicle 20 is traveling or stationary. It will be appreciated that the vehicle 20 can be used for various purposes. While aspects of the present invention are preferably used in connection with the vehicle 20, an alternative vehicle could be used. Furthermore, aspects of the present invention could be incorporated into a permanently fixed enclosure.

The illustrated slideout 24 is shiftable between an inboard position (see FIG. 1) and an outboard position (see FIG. 2) to selectively configure the enclosed space. The slideout 24 preferably includes a slideout floor 36, a slideout ceiling 38, a side wall 40, and an end wall 42 that are fixed to one another. The slideout 24 also preferably includes windows 44, a stop 46, and rollers 48. The rollers 48 are attached to an inboard margin 50 of the slideout floor 36. The inboard margin 50 engages a seal 52 of the chassis 22.

As the slideout 24 moves between the inboard and outboard positions, the rollers 48 are in rolling engagement with the chassis floor 28. In the inboard position, an exterior surface 54 of side wall 40 is preferably substantially flush with an exterior surface 56 of side wall 32 (see FIG. 1). In the outboard position, the stop 46 preferably engages the side wall 32 to restrict further outboard sliding movement of the slideout 24 (see FIG. 2).

In the usual manner, the vehicle 20 includes a powered drive (not shown) to move the slideout 24 between the inboard and outboard positions. While the vehicle 20 includes the illustrated slideout 24, the principles of the present invention are applicable where the slideout 24 has an alternative configuration. It will also be appreciated that the cabinet assembly 26 could be installed on the chassis floor 28 or on another part of the vehicle 20. Yet further, it is within the scope of the present invention where the cabinet assembly 26 is installed in a fixed structure instead of a vehicle.

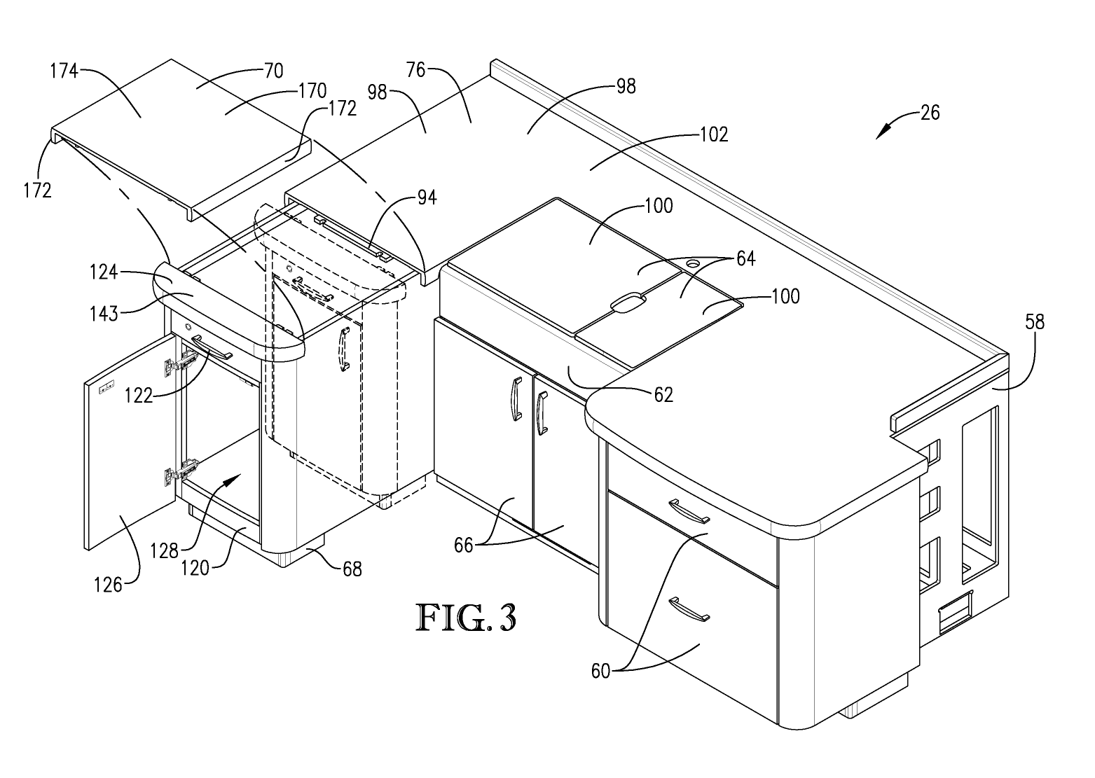

Turning to FIGS. 3 and 5-10, the cabinet assembly 26 provides storage space and a work area within the enclosed space S. As will be explained, the cabinet assembly 26 is selectively configurable to enlarge the work area (e.g., when the slideout 24 is in the outboard position).

The illustrated cabinet assembly 26 preferably provides a galley for the vehicle 20. However, it will be appreciated that the cabinet assembly 26 could be configured and installed in the vehicle 20 for other purposes. The cabinet assembly 26 preferably includes a cabinet case 58, sliding drawers 60, sink 62, removable sink covers 64, doors 66, pullout enclosure 68, and removable countertop piece 70. As will be discussed, the countertop piece 70 is removably supported by the cabinet case 58 and the pullout enclosure 68.

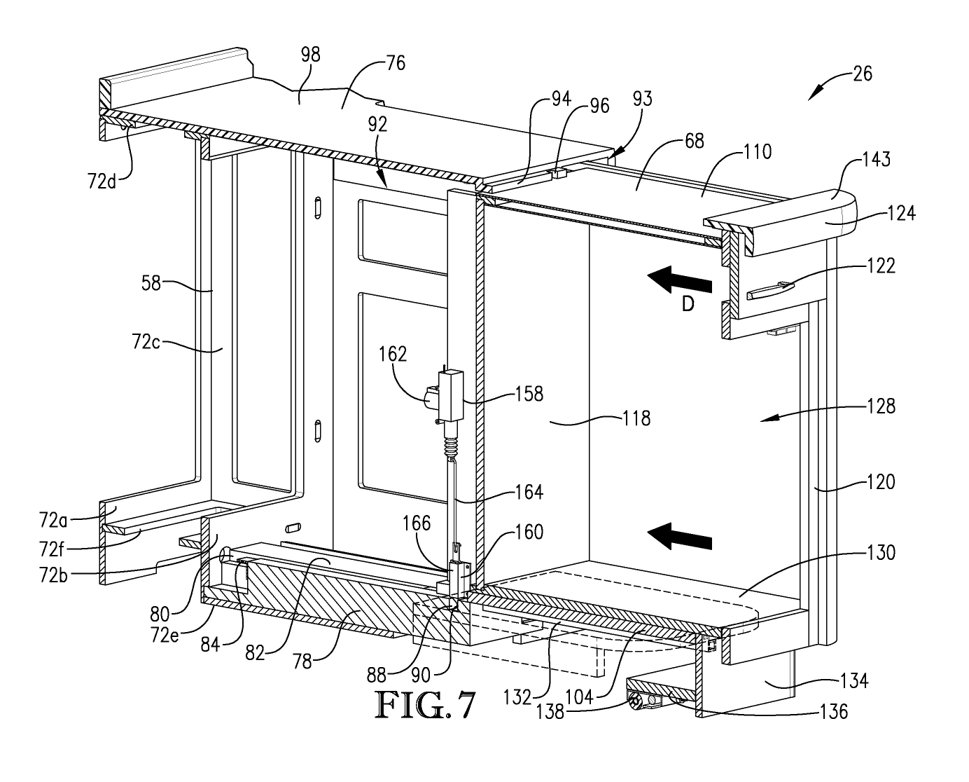

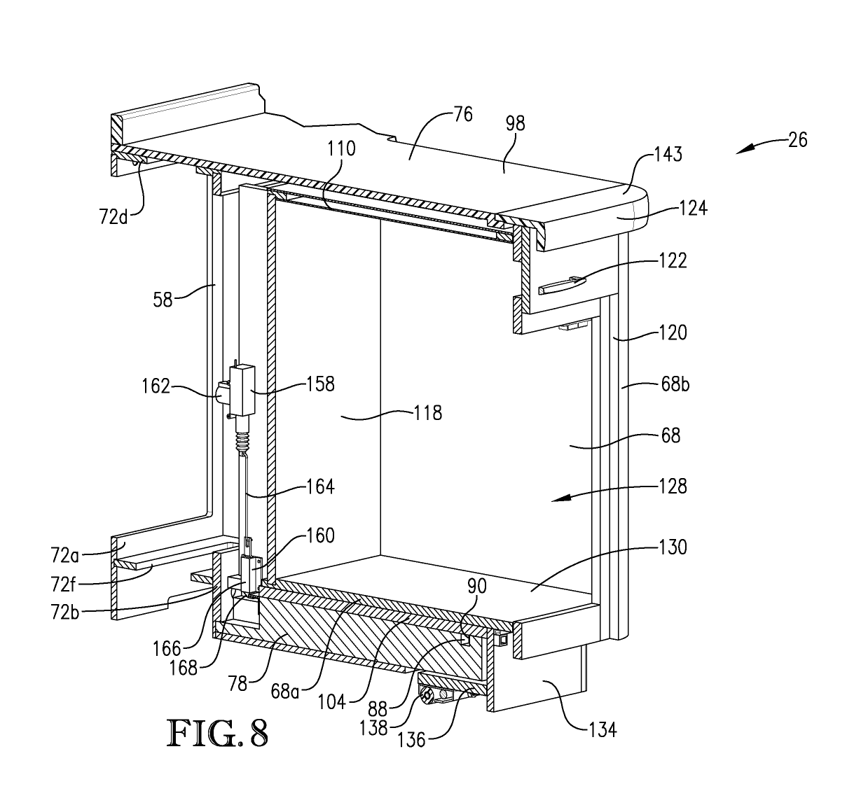

The cabinet case 58 provides a rigid framework that supports the drawers 60, sink 62, doors 66, and the pullout enclosure 68 while providing a galley workspace. The cabinet case 58 preferably includes, among other things, frame members 72, side wall 74, and a countertop 76 that are securely fixed to one another (see FIGS. 7 and 8). The cabinet case 58 also preferably includes a slide base 78.

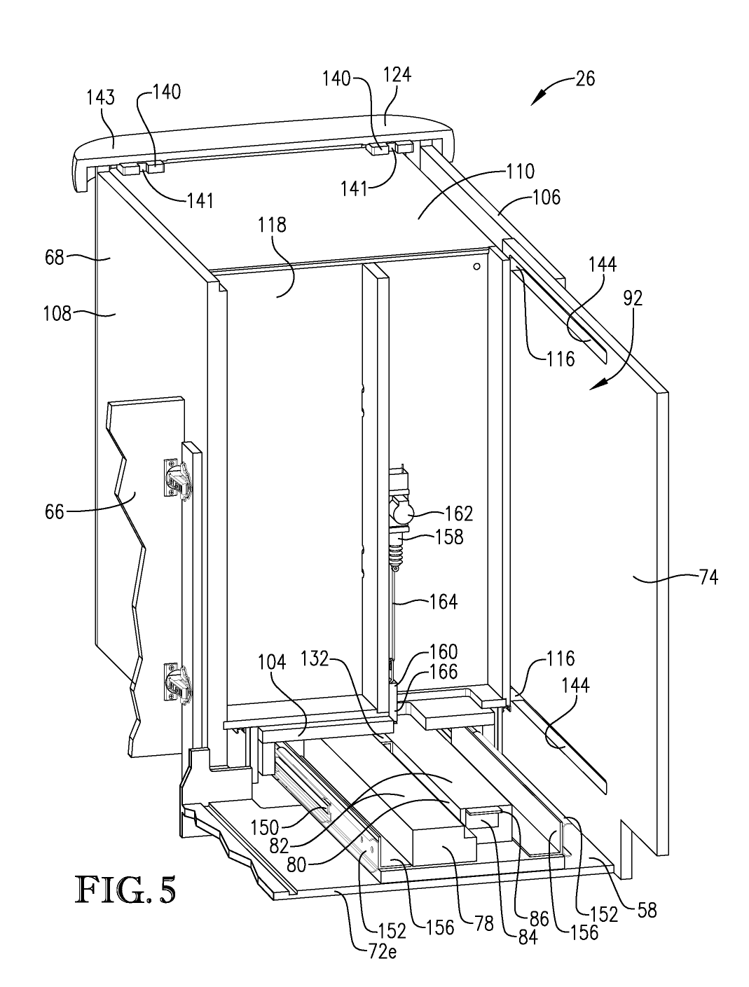

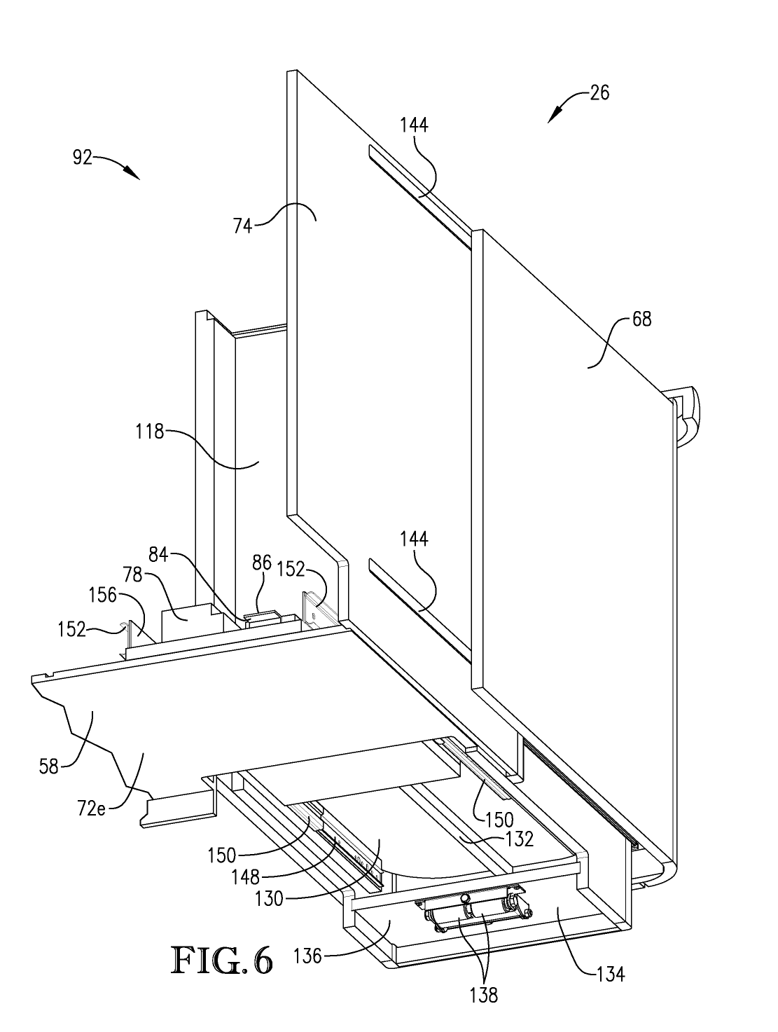

As will be described, the slide base 78 supports the pullout enclosure 68. The slide base 78 presents a longitudinal groove 80 and support surfaces 82 on opposite sides of the groove 80 (see FIG. 5). The slide base 78 includes a bracket 84 that presents a locking shoulder 86 (see FIGS. 5 and 6). The slide base 78 also presents an opening 88 defined partly by a second locking shoulder 90 (see FIGS. 7 ad 8). As will be discussed, the locking shoulders 86,90 can be engaged by a latch to secure the pullout enclosure 68 in either a retracted position (see FIG. 8) or an extended position (see FIG. 7).

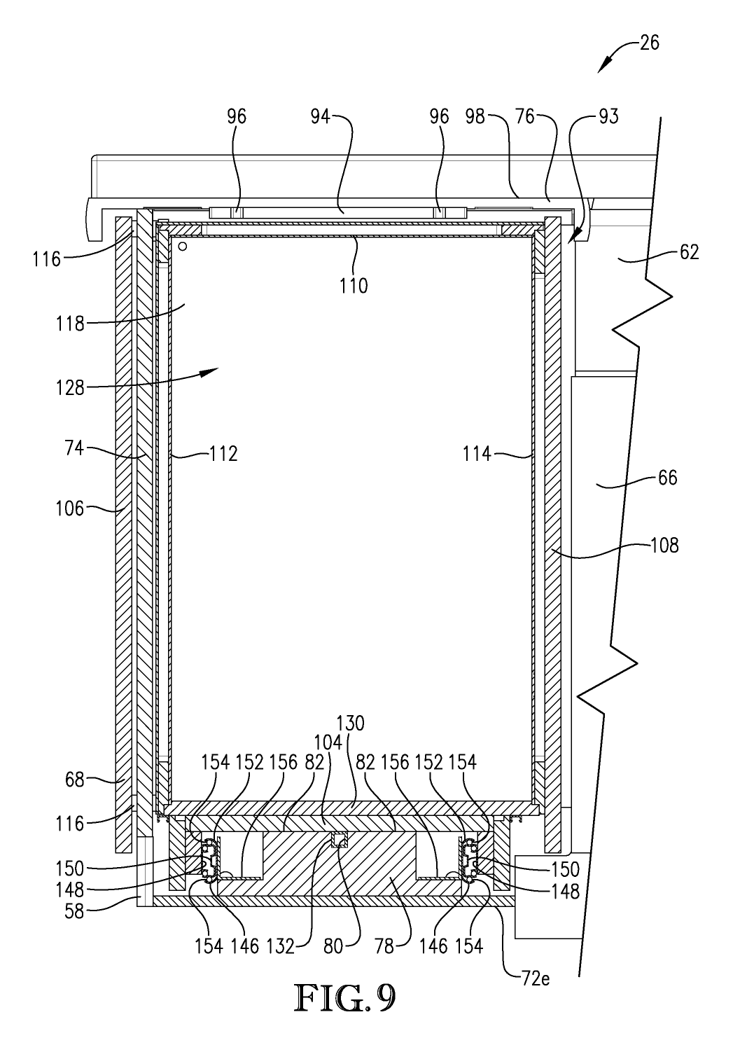

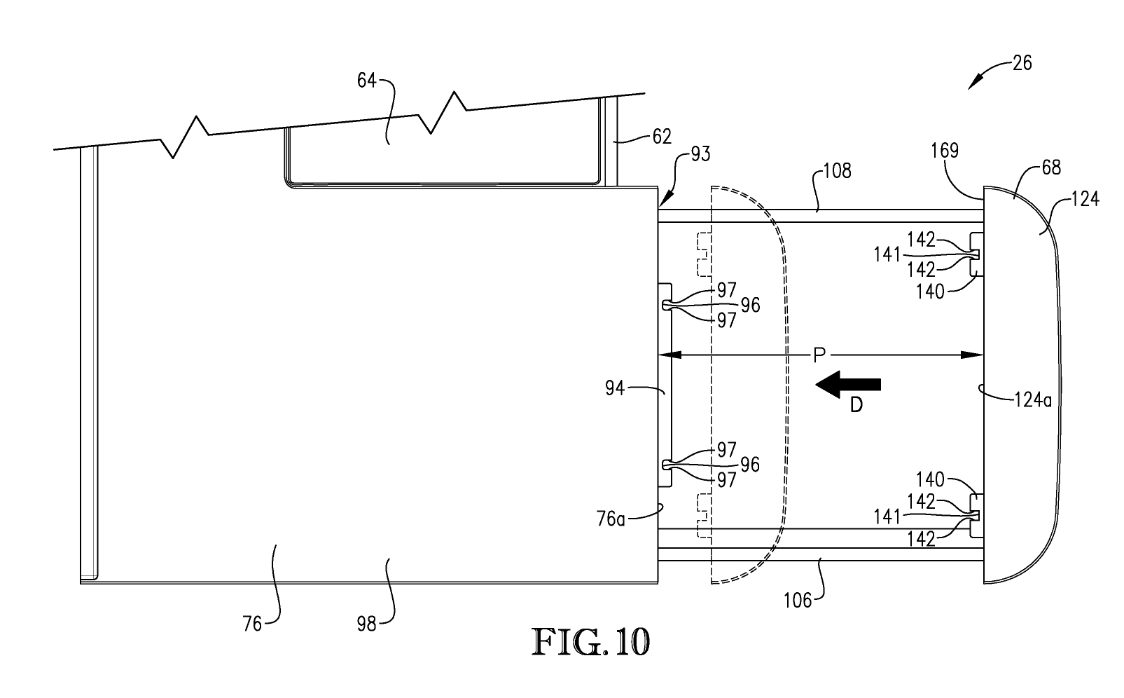

Frame members 72, side wall 74, and countertop 76 of the cabinet case 58 cooperatively define a pocket 92 that at least partly receives the pullout enclosure 68 (see FIG. 7). The illustrated pocket 92 comprises a space that extends along a longitudinal sliding direction D (see FIG. 7). The cabinet case 58 also presents an open front face 93 (see FIGS. 9 and 10) that provides access to the pocket 92. As will be shown, the pullout enclosure 68 projects through the open front face 93.

The cabinet case 58 also preferably includes a tab 94 fixed to and projecting from the countertop 76 (see FIGS. 7 and 9). The tab 94 presents a pair of slots 96 spaced apart from one another. Each slot 96 is defined at least partly by opposed shoulders 97 (see FIG. 10). As will be discussed, the tab 94 is configured to removably receive the countertop piece 70.

The cabinet case 58 is preferably fixed to and moves with the floor 36 of the slideout 24 between the inboard and outboard positions. However, the principles of the present invention are applicable for the cabinet case to 58 be alternatively positioned within the enclosed space S. For instance, the cabinet case 58 could be fixed to the chassis floor 28.

The countertop 76 preferably presents a substantially planar countertop surface 98. The sink covers 64 preferably present cover surfaces 100 (see FIG. 3). When the sink covers 64 are installed, the countertop surface 98 and cover surfaces 100 are coplanar and form parts of a cabinet work surface 102 (see FIG. 2).

Turning to FIGS. 5-10, the pullout enclosure 68 is configured to receive one or more items (not shown) and is slidably attached to the cabinet case 58 to slide laterally into and out of the pocket 92.

The pullout enclosure 68 preferably includes a base 104, exterior walls 106,108, top wall 110, and interior side walls 112,114 (see FIG. 9). The pullout enclosure 68 further includes connectors 116 and back wall 118 (see FIGS. 5 and 9). Yet further, the pullout enclosure includes face frame 120, pull 122, countertop 124, and a door 126 (see FIGS. 3, 7, and 8). The pullout enclosure 68 preferably defines a storage space 128 configured to receive items (not shown).

The base 104 includes a floor 130, a slide tube 132, and a support 134 that are attached to one another (see FIGS. 6-9). The support 134 includes frame 136 and a roller 138 rotatably mounted to the frame 136 (see FIG. 6). The roller 138 is configured to roll across the chassis floor 28. The base 104 and the top wall 110 are both connected directly to interior side walls 112,114, back wall 118, and face frame 120.

The pullout enclosure 68 also preferably includes a pair of tabs 140 that are fixed to and project from the countertop 124 (see FIGS. 5 and 10). Each tab 140 preferably presents a slot 141. Each slot 141 is defined at least partly by opposed shoulders 142 (see FIG. 10). As will be discussed, the tabs 140 are configured to removably receive to the countertop piece 70.

Similar to countertop 76, the countertop 124 preferably presents a countertop surface 143. Preferably, the countertop surfaces 98,143 are substantially coplanar (see FIG. 8). However, it will be appreciated that the countertop surfaces 98,143 could be alternatively positioned relative to one another (e.g., where the countertop surfaces 98,143 are vertically offset from each other).

The exterior wall 106 is preferably spaced from the interior side wall 112. However, the walls 106,112 are preferably attached to one another by connectors 116. Each connector 116 preferably comprises a unitary rod. The walls 106,112 are spaced apart to receive the side wall 74 of the cabinet case 58. Specifically, the side wall 74 presents a pair of slots 144 that slidably receive the connectors 116 (see FIGS. 5 and 6). Thus, the walls 106,112 remain attached to one another as the pullout enclosure 68 slides relative to the cabinet case 58. The illustrated arrangement of the side wall 74 between walls 106,112 enables the exterior wall 106 to at least partly cover an exterior surface 145 of the side wall 74. As a result, the exterior wall 106 serves as a false wall that at least partly hides the side wall 74 from view.

[attaching the enclosure to the cabinet case]

The depicted cabinet assembly 26 further includes a pair of roller slides 146 that removably connect the pullout enclosure 68 and the cabinet case 58 (see FIG. 9). The roller slides 146 each include inner, middle, and outer slide arms 148,150,152 connected to one another by ball bearings 154 (see FIG. 9). The outer slide arms 152 of the roller slides 146 are mounted to angle brackets 156 of the slide base 78. The inner slide arms 148 are mounted to the base 104 of the pullout enclosure 68. While the illustrated roller slides 146 are preferably used to mount the pullout enclosure 68, the roller slides 146 could be alternatively configured without departing from the scope of the present invention. Also, for some aspects of the present invention, the cabinet assembly 26 could be devoid of roller slides 146.

The illustrated pullout enclosure 68 is further supported for sliding movement by structure other than the roller slides 146. Specifically, the slide tube 132 is preferably received by and slidably engages the groove 80 of slide base 78. Furthermore, the base 104 is slidably mounted on the support surfaces 82 of slide base 78. However, it is within the scope of the present invention where the slide base 78 and/or the pullout enclosure 68 are alternatively configured to be slidably engaged with one another. Furthermore, for some aspects of the present invention, the slide base 78 could be spaced from the pullout enclosure 68.

In the illustrated embodiment, the roller 138 of support 134 preferably engages the chassis floor 28. Thus, as the pullout enclosure 68 is moved between the extended position (see FIG. 7) and the retracted position (see FIG. 8), the roller 138 preferably rolls along the floor 28. However, it is within the scope of the present invention where the roller 138 (or another part of the pullout enclosure 68) directly engages the floor 28. For instance, the exposed end of the pullout enclosure 68 could be cantilevered from the cabinet case 58 as the pullout enclosure 68 slides between the extended and retracted positions.

As the pullout enclosure 68 slides into the retracted position, a retractable section 68a of the pullout enclosure 68 preferably becomes retracted within the pocket 92 (see FIG. 8). At the same time, an exposed section 68b of the pullout enclosure 68 is preferably spaced outside of the pocket 92 (see FIG. 8). That is, the exposed section 68b is not received in the pocket 92. As the pullout enclosure 68 slides into the extended position, the retractable section 68a and the exposed section 68b are both preferably spaced outside of the pocket 92 (see FIG. 7).

In the illustrated embodiment, the cabinet assembly 26 defines a longitudinal pullout distance dimension P that the pullout enclosure 68 travels between the retracted and extended conditions (see FIG. 10). The pullout distance dimension P is preferably at least about six inches (6″) and, more preferably, is at least about twelve inches (12″). Most preferably, the pullout distance dimension P is about twenty inches (20″).

The pullout enclosure 68 is preferably operable to be extended once the slideout 24 is moved to the outboard position. That is, after the slideout 24 is moved outboard to enlarge the enclosed space S, the pullout enclosure 68 is moved to the extended position. However, the pullout enclosure 68 could be moved to the extended position while the slideout 24 is moved outboard or prior to any movement of the slideout 24 to the outboard position.

The pullout enclosure 68 is also preferably retracted before the slideout 24 is returned to the inboard position. However, the pullout enclosure 68 could be moved to the retracted position while the slideout 24 is moved inboard or after movement of the slideout 24 to the inboard position.

Turning to FIGS. 5, 7, and 8, the pullout enclosure 68 also preferably includes a pullout lock 158. The pullout lock 158 is preferably operable to secure the pullout enclosure 68 in either the retracted position or the extended position. The pullout lock 158 preferably includes a latch assembly 160, a motor 162, and a wire connector 164.

The latch assembly 160 includes a latch housing 166, a slidable latch 168 (see FIG. 8), and a spring (not shown). The latch assembly 160 is configured so that the spring normally urges the latch 168 into a locked position. The motor 162 can be selectively activated by a user to move the latch 168 into an unlocked position. The user can also selectively deactivate the motor 162 to permit the latch 168 to return to the locked position.

When the pullout enclosure 68 is in the extended position, the latch 168 can be extended into the opening 88 to engage the locking shoulder 90. When extended into locking engagement with the locking shoulder 90, the pullout lock 158 restricts movement of the pullout enclosure 68 out of the extended position.

Similarly, when the pullout enclosure 68 is in the retracted position, the latch 168 can be extended to engage the locking shoulder 86. When extended into locking engagement with the locking shoulder 86, the pullout lock 158 restricts movement of the pullout enclosure 68 out of the retracted position.

Turning to FIG. 10, the countertops 76,124 present opposed edge surfaces 76a,124a. When the pullout enclosure 68 is in the retracted position, the countertops 76,124 are positioned adjacent to one another. It will be appreciated that the edge surfaces 76a,124a may or may not actually contact one another in the retracted position.

The tabs 140 associated with countertop 124 are preferably laterally spaced from and located adjacent to opposite ends of the tab 94. Thus, in the retracted position, the tabs 94,140 preferably overlap one another along the sliding direction D. This arrangement allows the pullout enclosure 68 to be smoothly opened and closed without such movement being restricted by the tabs 94,140. However, it will be appreciated that the tabs 140 may come into at least some contact with the tab 94 in the retracted position. Such contact may be desirable to restrict relative lateral movement between the cabinet case 58 and the pullout enclosure 68.

In the extended position, the countertops 76,124 and the corresponding edge surfaces 76a,124a are preferably spaced from one another. The edge surfaces 76a,124a cooperatively define an open space 169 configured to receive the countertop piece 70.

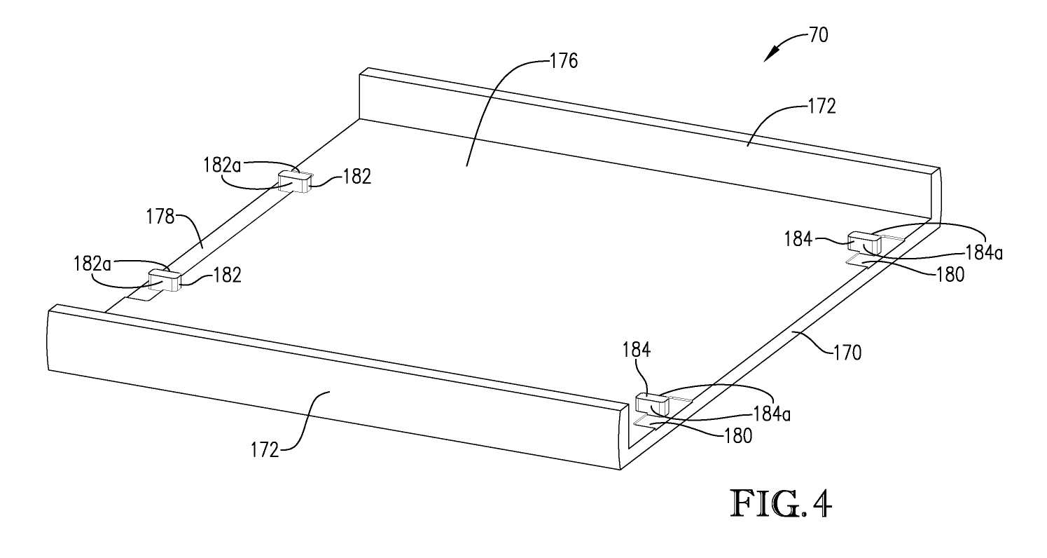

Turning to FIGS. 3 and 4, the illustrated countertop piece 70 is configured for removable insertion into the open space 169 between the countertops 76,124 when the pullout enclosure 68 is in the extended condition. The countertop piece 70 is unitary and preferably includes a top portion 170 and opposite side portions 172. The countertop piece 70 also presents upper and lower surfaces 174,176. The depicted lower surface 176 includes recessed margins 178,180 (see FIG. 4). The countertop piece 70 also preferably includes bosses 182,184 that project downwardly from the lower surface 176 and present oppositely facing shoulders 182a,184a (see FIG. 4).

The countertop piece 70 is preferably configured for insertion into the open space 169 in the extended position to expand the cabinet work surface 102. The countertop piece 70 is inserted by facing the lower surface 176 in a downward direction. The countertop piece 70 is then lowered so that the bosses 184 are inserted into slots 141 of tabs 140. When the bosses 184 are inserted into slots 141, the shoulders 184a are preferably positioned in engagement with corresponding shoulders 142 of the slots 141. Thus, the shoulders 142,184a cooperatively engage one another to restrict lateral movement of the countertop piece 70 relative to the pullout enclosure 68.

Similarly, the countertop piece 70 is lowered so that the bosses 182 are inserted into slots 96 of tab 94. When the bosses 182 are inserted into slots 96, the shoulders 182a are preferably positioned in engagement with corresponding shoulders 97 of the slots 96. Thus, the shoulders 97,182a cooperatively engage one another to restrict lateral movement of the countertop piece 70 relative to the pullout enclosure cabinet case 58. Also in the illustrated embodiment, the tab 94 is preferably received by recessed margin 178, and tabs 140 are preferably received by corresponding recessed margins 180.

However, it will be appreciated that the countertop piece 70 and/or the countertops 76,124 could be alternatively configured to provide removable insertion of the countertop piece 70. For instance, the countertop piece 70 could include an alternative number and/or configuration of bosses 182,184. Similarly, the countertops 76,124 could have an alternative number and/or configuration of tabs 94,140.

When inserted between the countertops 76,124, the countertop piece 70 preferably serves to lock the pullout enclosure 68 in the extended position. Also, the upper surface 174 of the inserted countertop piece 70 is preferably located so as to be substantially coplanar with the countertop surfaces 98,143, with the surfaces 98,143,174 cooperatively providing the work surface 102. However, it will be appreciated that the upper surface 174 could be alternatively positioned relative to countertop surfaces 98,143 (e.g., where the upper surface 174 is vertically offset relative to the countertop surfaces 98,143).

The countertop piece 70 is also preferably configured for being selectively removed from the open space 169. That is, the countertop piece 70 can be selectively removed from engagement with the countertops 76,124 to permit sliding of the pullout enclosure 68 from the extended position to the retracted position. In the illustrated embodiment, the countertop piece 70 is selectively removed by lifting the countertop piece 70 vertically until the bosses 182,184 are removed from engagement with the corresponding tabs 94,140.

In use, the cabinet assembly 26 can be selectively adjustably configured by a user. For instance, the user can selectively extend the pullout assembly 68 and install the countertop piece 70. If the latch 168 is engaged with the locking shoulder 86 in the retracted position, extension of the pullout assembly 68 first requires the latch 168 to be unlocked to permit sliding movement of the pullout assembly 68. With the latch 168 unlocked, the pullout assembly 68 can be moved from the retracted position to the extended position. The countertop piece 70 is then installed by inserting the countertop piece into the open space 169, with bosses 184 being inserted into slots 141 and bosses 182 being inserted into slots 96. Insertion of the countertop piece 70 preferably serves to lock the pullout enclosure in the extended position. If desired, the user can then move the latch 168 into engagement with the locking shoulder 90 (i.e., into the locked position) to secure the pullout assembly 68 in the extended position. It will be understood that the latch 168 can be locked either before, after, or at the same time as insertion of the countertop piece 70 between the countertops 76,124.

With the pullout assembly 68 extended, the user can selectively return the pullout assembly 68 to the retracted position. If the latch 168 is engaged with the locking shoulder 90 in the locked position, retraction of the pullout assembly 68 requires that the latch 168 be unlocked to permit sliding movement of the pullout assembly 68. If the countertop piece 70 is installed, retraction of the pullout assembly 68 also requires removal of the countertop piece 70 from engagement with the tabs 94,140. Where it is necessary to both unlock the latch 168 and remove the countertop piece 70, it will be appreciated that the latch 168 can be unlocked before, after, or at the same time as removal of the countertop piece 70. With the countertop piece 70 removed and the latch 168 unlocked, the pullout assembly 68 is free to be moved into the pocket 92 until the countertops 76,124 engage one another. If desired, the user can then move the latch 168 into engagement with the locking shoulder 86 to secure the pullout assembly 68 in the retracted position.

Although the above description presents features of preferred embodiments of the present invention, other preferred embodiments may also be created in keeping with the principles of the invention. Such other preferred embodiments may, for instance, be provided with features drawn from one or more of the embodiments described above. Yet further, such other preferred embodiments may include features from multiple embodiments described above, particularly where such features are compatible for use together despite having been presented independently as part of separate embodiments in the above description.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A cabinet assembly operable to support items above a floor, said cabinet assembly comprising:
a cabinet case operable to be mounted on the floor and at least partly defining a cabinet pocket;
a pullout enclosure operable to receive one or more of the items and slidably attached to the cabinet case,
said pullout enclosure being slidable relative to the cabinet case between a retracted position and an extended position,
said pullout enclosure comprising an exposed section and a retractable section,
said pullout enclosure being configured such that when said pullout enclosure is in the retracted position, the retractable section is received in the pocket and the exposed section is not received in the pocket,
said pullout enclosure being configured such that when said pullout enclosure is in the extended position, neither the retractable section nor the exposed section are received in the pocket,
said cabinet case and said pullout enclosure comprising respective countertops that are adjacent to one another when the pullout enclosure is in the retracted position and spaced from one another when the pullout enclosure is in the extended position; and
a removable countertop piece configured for (i) insertion into the space between the countertops of the cabinet case and the pullout enclosure when the pullout enclosure is in the extended position to thereby lock the pullout enclosure in the extended position and (ii) removal from the space between the countertops of the cabinet case and the pullout enclosure to thereby permit sliding of the pullout enclosure from the extended position into the retracted position.

2. The cabinet assembly as claimed in claim 1,
said removable countertop piece presenting an upper surface that is substantially coplanar with the upper surfaces of the cabinet case countertop and the pullout enclosure countertop when the pullout enclosure is in the extended position and the removable countertop piece is inserted in the space between the countertops of the cabinet case and the pullout enclosure.

3. The cabinet assembly as claimed in claim 1,
said pullout enclosure sliding at least 12 inches from said retracted position to said extended position.

4. The cabinet assembly as claimed in claim 1,
said pullout enclosure including a support operable to engage the floor in the extended and retracted positions.

5. The cabinet assembly as claimed in claim 4,
said support including a rotatable wheel operable to roll along the floor as the pullout enclosure slides between the extended and retracted positions.

6. The cabinet assembly as claimed in claim 1,
said cabinet case and said pullout enclosure each including a tab that presents support surfaces, with the support surfaces cooperatively supporting the countertop piece in the extended position,
said countertop piece presenting shoulders that engage the tabs to restrict lateral movement of the countertop piece relative to the cabinet case and the pullout enclosure.

7. The cabinet assembly as claimed in claim 1,
said cabinet case including a side wall that presents opposite interior and exterior surfaces, with the interior surface at least partly defining the pocket,
said pullout enclosure including an outer wall that at least partly covers the exterior surface.

8. The cabinet assembly as claimed in claim 7,
said pullout enclosure including an inner wall located at least partly in the pocket and a connector that extends into and out of the pocket to interconnect the inner and outer walls.

9. The cabinet assembly as claimed in claim 8,
said side wall presenting a longitudinal slot,
said connector being slidably received in the slot and sliding along the length thereof as the pullout enclosure slides into and out of the extended position.

10. The cabinet assembly as claimed in claim 1; and
a pullout lock including a shiftable latch,
said pullout lock being mounted on one of the cabinet case and the pullout enclosure, with the other one of the cabinet case and the pullout enclosure presenting a first and second locking shoulders,
said latch being shiftable into and out of locking engagement with the first locking shoulder in the extended position to restrict relative movement between the cabinet case and the pullout enclosure,
said latch being shiftable into and out of locking engagement with the second locking shoulder in the retracted position to restrict relative movement between the cabinet case and the pullout enclosure.

11. A vehicle comprising:
a vehicle chassis;
a slideout cooperating with the chassis to define an enclosed space,
said slideout being shiftably mounted to the chassis and slidable into and out of the chassis to change the size of the enclosed space; and
a cabinet assembly operable to support items in the enclosed space, said cabinet assembly including—
a cabinet case mounted in the enclosed space and at least partly defining a cabinet pocket,
a pullout enclosure operable to receive one or more of the items and slidably attached to the cabinet case,
said pullout enclosure being slidable relative to the cabinet case between a retracted position and an extended position,
said pullout enclosure comprising an exposed section and a retractable section,
said pullout enclosure being configured such that when said pullout enclosure is in the retracted position, the retractable section is received in the pocket and the exposed section is not received in the pocket,
said pullout enclosure being configured such that when said pullout enclosure is in the extended position, neither the retractable section nor the exposed section are received in the pocket,
said cabinet case and said pullout enclosure comprising respective countertops that are adjacent to one another when the pullout enclosure is in the retracted position and spaced from one another when the pullout enclosure is in the extended position, and
a removable countertop piece configured for (i) insertion into the space between the countertops of the cabinet case and the pullout enclosure when the pullout enclosure is in the extended position to thereby lock the pullout enclosure in the extended position and (ii) removal from the space between the countertops of the cabinet case and the pullout enclosure to thereby permit sliding of the pullout enclosure from the extended position into the retracted position.

12. The vehicle as claimed in claim 11,
said removable countertop piece presenting an upper surface that is substantially coplanar with the upper surfaces of the cabinet case countertop and the pullout enclosure countertop when the pullout enclosure is in the extended position and the removable countertop piece is inserted in the space between the countertops of the cabinet case and the pullout enclosure.

13. The vehicle as claimed in claim 11,
said pullout enclosure sliding at least 12 inches from said retracted position to said extended position.

14. The vehicle as claimed in claim 11; and
a floor located below the pullout enclosure,
said pullout enclosure including a support that engages the floor in the extended and retracted positions.

15. The vehicle as claimed in claim 14,
said support including a rotatable wheel that rolls along the floor as the pullout enclosure slides between the extended and retracted positions.

16. The vehicle as claimed in claim 11,
said cabinet case and said pullout enclosure each including a tab that presents support surfaces, with the support surfaces cooperatively supporting the countertop piece in the extended position,
said countertop piece presenting shoulders that engage the tabs to restrict lateral movement of the countertop piece relative to the cabinet case and the pullout enclosure.

17. The vehicle as claimed in claim 11,
said cabinet case including a side wall that presents opposite interior and exterior surfaces, with the interior surface at least partly defining the pocket,
said pullout enclosure including an outer wall that at least partly covers the exterior surface,
said pullout enclosure including an inner wall located at least partly in the pocket and a connector that extends into and out of the pocket to interconnect the inner and outer walls.

18. The vehicle as claimed in claim 11; and
a pullout lock including a shiftable latch,
said pullout lock being mounted on one of the cabinet case and the pullout enclosure, with the other one of the cabinet case and the pullout enclosure presenting a first and second locking shoulders,
said latch being shiftable into and out of locking engagement with the first locking shoulder in the extended position to restrict relative movement between the cabinet case and the pullout enclosure,
said latch being shiftable into and out of locking engagement with the second locking shoulder in the retracted position to restrict relative movement between the cabinet case and the pullout enclosure.

19. The vehicle as claimed in claim 11,
said cabinet case being mounted on the slideout,
said pullout enclosure being slidable along the floor of the vehicle chassis.

20. A method of adjustably configuring a cabinet assembly that includes a cabinet case and a pullout assembly, with the case presenting a pocket to receive the pullout assembly, and with the cabinet case and the pullout assembly including respective countertops, said method comprising the steps of:
(a) sliding the pullout assembly from a retracted position, where the retractable section of the pullout assembly is received in the pocket, to an extended position, where the retractable section is outside of the pocket;
(b) after step (a), inserting a countertop piece into the space between the countertops of the cabinet case and the pullout enclosure to lock the pullout enclosure in the extended position;
(c) after step (b), removing the countertop piece from the space between the countertops to permit sliding of the pullout enclosure toward the retracted position; and
(d) after step (c), sliding the pullout assembly from the extended position to the retracted position.

21. The method as claimed in claim 20,
step (a) including the step of sliding the pullout assembly at least 12 inches from the retracted position to the extended position.

22. The method as claimed in claim 20,
said pullout enclosure including a rotatable wheel that engages a floor to at least partly support the pullout enclosure, with the wheel rolling along the floor during steps (a) and (d) as the pullout enclosure slides between the extended and retracted positions.

23. The method as claimed in claim 20,
step (b) including the step of positioning the countertop piece so that an upper surface thereof is substantially coplanar with the upper surfaces of the cabinet case countertop and the pullout enclosure countertop.

24. The method as claimed in claim 20,
said cabinet case and said pullout enclosure each including a tab that presents support surfaces,
step (b) including the step positioning the countertop piece on the support surfaces of the tabs.
